(19) United States
(12) Patent Application Publication
(10) Pub. No.: US 2026/0245497 A1
(43) Pub. Date: Aug. 20, 2026

(54) MICRO LED DRIVING CIRCUIT

(71) Applicant: SEOUL NATIONAL UNIVERSITY R&DB FOUNDATION, Seoul (KR)

(72) Inventors: Soo Yeon LEE, Seoul (KR); Kyeong Soo KANG, Seoul (KR); Chan Jin PARK, Seoul (KR)

(73) Assignee: SEOUL NATIONAL UNIVERSITY R&DB FOUNDATION, Seoul (KR)

(21) Appl. No.: 18/993,265

(22) PCT Filed: Jul. 12, 2023
(86) PCT No.: PCT/KR2023/009956

§ 371 Date: Jan. 10, 2025

(30) Foreign Application Priority Data
Jul. 12, 2022 (KR) 10-2022-0085415
Jul. 12, 2023 (KR) 10-2023-0090383

(51) Int. Cl. G09G 3/32

(52) U.S. Cl. CPC G09G 3/32; G09G 2300/0842; G09G 2310/08; G09G 2320/0233; G09G 2320/0242; G09G 2320/064

(57) ABSTRACT

The present invention relates to a micro LED driving circuit, comprising: a PWM circuit configured to control the emission time of the micro LED; and a CCG circuit configured to control the supply of a constant current during the emission of the micro LED based on the PWM data voltage.

### DESCRIPTION

### Technical Field

The present disclosure relates to a display device, and more particularly, to a micro LED display device comprising a pixel array composed of self-emissive elements and a driving circuit included therein.

### Background

Conventionally, in display panels that drive inorganic light-emitting devices (hereinafter referred to as “LEDs”) such as red LEDs, green LEDs, and blue LEDs as subpixels, the grayscale of subpixels was expressed through Pulse Amplitude Modulation (PAM) driving.

In this case, the magnitude of the driving current affects not only the grayscale of the emitted light but also the wavelength, reducing the color reproducibility of the image. Such a reduction in color reproducibility is particularly pronounced in micro LEDs.

A typical micro LED refers to an ultra-small LED with a size of 100 μm or less, and due to its small size and low power consumption, it has the advantages of enabling low-power, compact, and lightweight displays.

Additionally, unlike organic light-emitting diodes (OLEDs), which show weaknesses in luminous efficiency and lifespan, micro LEDs exhibit superior efficiency and longevity, operating even in extreme conditions below −20° C. and above 100° C. Such potential as a next-generation display has led many domestic and international companies to strengthen their investment in micro LED technology.

The micro LED driving circuit is a circuit designed to implement pixels and grayscale used for image representation by controlling the scanning signals and data voltages of micro LEDs arranged in a matrix format. Typically, one pixel driving circuit is used to drive a single pixel.

Conventional OLED-based driving circuits used a PAM (Pulse Amplitude Modulation) driving method to represent grayscale by the amount of current flowing through the OLED. Conventional OLED-based driving circuits, when representing grayscale, used the PAM (Pulse Amplitude Modulation) driving method to express grayscale through the amount of current flowing through the OLED. When using the PAM method, grayscale is expressed by adjusting the current value, and the amount of current flowing through the OLED is controlled by the driving transistor (Driving TFT) of the driving circuit.

However, micro LEDs have a characteristic where the wavelength fluctuates depending on the amount of current, and when grayscale is expressed using the PAM driving method, a wavelength shift occurs, causing color changes during the pixel driving process, which leads to screen distortion, making it difficult to use the PAM driving method.

Particularly, in the case of implementing a large display by connecting multiple modular-type micro LED display panels, differences in color wavelengths occur between the modules, exacerbating the issues with grayscale representation.

Therefore, it is necessary to develop a driving method for self-emissive display panels that can improve color reproducibility, while also addressing issues such as power consumption, luminance uniformity, and horizontal crosstalk.

### DESCRIPTION

### Technical Problem

The present invention aims to solve the aforementioned problems of the prior art, and its purpose is to improve issues arising when using PAM driving circuit methods in micro LED display devices and to provide micro LED display devices with enhanced color reproducibility.

Another objective of the present disclosure is to provide a micro LED display device that, unlike the PAM driving method which represents grayscale through the amount of current, fixes the amount of current and implements grayscale expression by controlling the emission time.

Another objective of the present disclosure is to provide a micro LED display device and a driving method that deliver enhanced color reproducibility for input image signals.

Another objective of the present disclosure is to propose a subpixel circuit capable of driving inorganic light-emitting devices more efficiently and stably, and to provide a display device and its driving method that include this circuit.

Another objective of the present disclosure is to optimize the design of various circuits for driving inorganic light-emitting devices, thereby providing a display device and a driving method that include a driving circuit suitable for high-density integration.

Another objective of the present disclosure is to provide a display device and a driving method capable of addressing luminance uniformity issues caused by threshold voltage or mobility variations in driving transistors.

The technical objectives to be achieved by the present invention are not limited to the matters mentioned above, and other technical challenges not explicitly stated may be understood and considered by those skilled in the art based on the embodiments of the present invention described below.

### Means for Solving the Problem

To achieve the above objectives, a micro LED driving circuit according to one embodiment of the present invention comprises:
a PWM circuit unit for adjusting the emission time of the micro LED; and a CCG circuit unit for controlling a constant current supply during the emission of the micro LED based on the PWM data voltage (V_{DATA_PWM}).

According to one embodiment, the PWM circuit unit includes a PWM circuit driving transistor (T_{PWM}) and a PWM circuit capacitor (C_{PWM}), and the CCG circuit unit includes a CCG circuit driving transistor and a CCG circuit capacitor.

According to one embodiment, the PWM circuit capacitor (C_{PWM}) performs both PWM data injection (PWM data input) and threshold voltage compensation (T_{PWM} V_{TH}) of the PWM circuit driving transistor simultaneously, and the CCG circuit capacitor (C_{CCG}) performs both CCG data injection (CCG data input) and threshold voltage compensation (T_{CCG} V_{TH}) of the CCG circuit driving transistor simultaneously.

According to one embodiment, after the PWM data injection (PWM data input) and threshold voltage compensation (T_{PWM} V_{TH}) of the PWM circuit driving transistor are performed, the CCG data injection (CCG data input) and threshold voltage compensation (T_{CCG} V_{TH}) of the CCG circuit driving transistor may then be performed.

According to one embodiment, the PWM circuit unit includes seven additional switching transistors, and the CCG circuit unit includes five additional switching transistors.

According to one embodiment, during the emission time of the micro LED, the V_{SWEEP} value gradually increases, and as one side of the CCG circuit capacitor (C_{CCG}) is connected to the ground, the CCG circuit capacitor discharges, extinguishing the micro LED and thereby adjusting the emission time.

According to one embodiment, the PWM circuit capacitor (C_{PWM}) senses the threshold voltage of the PWM circuit driving transistor (T_{PWM}), and the CCG circuit capacitor (C_{CCG}) senses the threshold voltage of the CCG circuit driving transistor (T_{CCG}).

According to one embodiment, the threshold voltage sensing of the PWM circuit driving transistor (T_{PWM}) and the threshold voltage sensing of the CCG circuit driving transistor (T_{CCG}) may be performed in the same circuit stage.

According to one embodiment, the threshold voltage sensing of the PWM circuit unit and the CCG circuit unit may be performed using a source follower method.

According to one embodiment, the PWM circuit capacitor (C_{PWM}) may store the threshold voltage of the PWM circuit driving transistor (T_{PWM}), and the CCG circuit capacitor (C_{CCG}) may store the threshold voltage of the CCG circuit driving transistor (T_{CCG}).

According to one embodiment, the PWM circuit unit may further include a data voltage storage capacitor (C_{DATA}).

According to one embodiment, the data voltage storage capacitor (C_{DATA}) may store the data voltage (V_{DATA}) through a switching transistor of the PWM circuit unit directly connected to the data voltage.

According to one embodiment, the PWM circuit unit may include a total of five PWM circuit switching transistors, and the CCG circuit unit may include a total of four switching transistors.

According to one embodiment, the micro LED may emit light as V_{SWEEP} gradually decreases, and the emission may stop when V_{SWEEP} V reaches a certain level.

According to one embodiment, the driving circuit may operate divided into a total of four stages, from the first stage to the fourth stage.

To achieve the aforementioned objective, a micro LED display device according to another embodiment of the present invention comprises: a display panel including a pixel array in which pixels composed of a plurality of inorganic light-emitting elements are arranged in a plurality of row lines, and sub-pixel circuits provided for each of the plurality of inorganic light-emitting elements to supply driving current to the inorganic light-emitting elements; and a driving unit configured to set image data voltages in the sub-pixel circuits of the display panel in row line order during a data setting period, and to drive the sub pixel circuits such that the driving current is supplied to the inorganic light-emitting elements of the pixel array in row line order based on a sweep signal that sweeps from a first voltage to a second voltage during a light-emission period and the set image data voltage, wherein the sub-pixel circuit includes: a PWM circuit configured to control the emission time of the micro LED; and a CCG circuit configured to control a constant current to flow during the emission of the micro LED.

### Advantageous Effects

The driving circuit proposed in the present invention allows for effective control of the emission time of micro LEDs in a micro LED display device and enables efficient threshold voltage compensation in the driving circuit.

### BRIEF DESCRIPTION OF THE DRAWINGS

FIG. 1 is a detailed circuit diagram of a micro LED driving circuit according to an embodiment of the present invention.

FIG. 2 is a signal sequence diagram of a micro LED driving circuit according to an embodiment of the present invention.

FIG. 3 is a diagram illustrating the operational principle of the first stage (Reset stage) of a micro LED driving circuit according to an embodiment of the present invention.

FIG. 4 is a diagram illustrating the operational principle of the second stage (PWM Data Input & T__{PWM} Circuit V_{TH} Compensation) of a micro LED driving circuit according to an embodiment of the present invention.

FIG. 5 is a diagram illustrating the operational principle at the beginning of the third stage (CCG Data Input & T__{PWM} Circuit V_{TH} Compensation) of a micro LED driving circuit according to an embodiment of the present invention.

FIG. 6 is a diagram illustrating the operational principle at the later phase of the third stage (CCG Data Input & T__{PWM} Circuit V_{TH} Compensation) of a micro LED driving circuit according to an embodiment of the present invention.

FIG. 7 is a diagram illustrating the operational principle of the fourth stage (Emission) of a micro LED driving circuit according to an embodiment of the present invention.

FIG. 8 is a detailed circuit diagram of a micro LED driving circuit according to another embodiment of the present invention.

FIG. 9 is a signal sequence diagram of a micro LED driving circuit according to another embodiment of the present invention.

FIG. 10 is a diagram illustrating the operational principle of the first stage (Reset stage) of a micro LED driving circuit according to an embodiment of the present invention.

FIG. 11 is a diagram illustrating the operational principle of the second stage (V_{TH} Compensation of T_{PWM} & T_{CCG}) of a micro LED driving circuit according to an embodiment of the present invention.

FIG. 12 is a diagram illustrating the operational principle of the third stage (PWM Data Input) of a micro LED driving circuit according to an embodiment of the present invention.

FIG. 13 is a diagram illustrating the operational principle at the initial phase of the fourth stage (Emission) of a micro LED driving circuit according to an embodiment of the present invention.

FIG. 14 is a diagram illustrating the operational principle at the later phase of the fourth stage (Emission) of a micro LED driving circuit according to an embodiment of the present invention.

FIG. 15 is a schematic diagram illustrating an embodiment of the pixel structure of a micro LED display device equipped with a micro LED driving circuit according to an embodiment of the present invention.

FIG. 16 is a block diagram illustrating the configuration of a micro LED display device equipped with a micro LED driving circuit according to an embodiment of the present invention.

### MORE FOR INVENTION

Hereinafter, embodiments of the present invention will be described in detail with reference to the accompanying figures. It should be noted that reference numerals are assigned to components in the figures such that the same components are given the same numerals as much as possible, even if they appear in different figures. Additionally, detailed descriptions of known configurations or functions may be omitted if they are deemed to hinder the understanding of the embodiments of the present invention.

The present invention proposes a micro LED driving circuit characterized by using a PWM (Pulse Width Modulation) method to represent grayscale by fixing the current value and adjusting the emission time.

The driving circuit includes a configuration in which a PWM (Pulse Width Modulation) circuit and a CCG (Constant Current Generation) circuit are combined. Specifically, the PWM circuit adjusts the emission time of the micro LED by controlling the pulse width, while the CCG circuit ensures that a constant current flows during the emission of the micro LED.

The transistors used in the driving circuit may be thin-film transistors (TFTs). These transistors may be a-IGZO thin-film transistors.

This specification presents two types of micro LED driving circuits based on the common principle described above, but the technical idea of the present invention is not necessarily limited thereto.

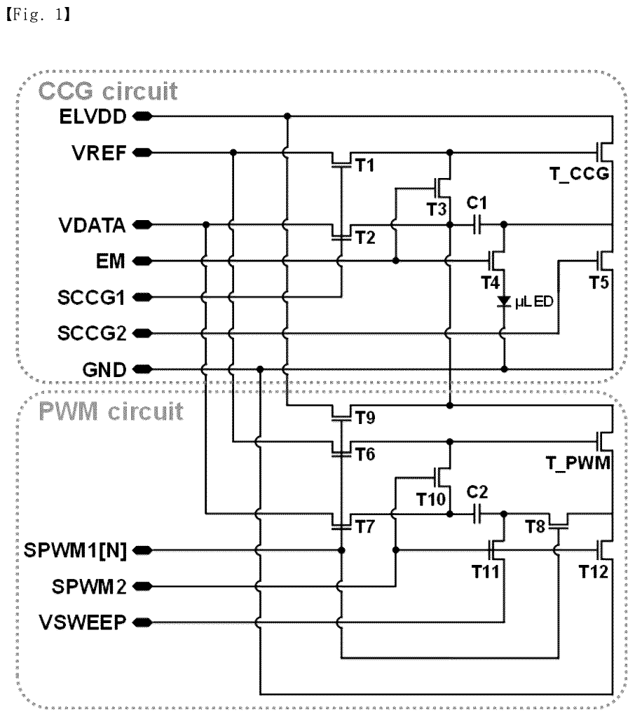

Hereinafter, the micro LED driving circuit and its operation method proposed in an embodiment of the present invention will be described in detail with reference to FIGS. 1 to 7. Although only one circuit diagram is presented in FIGS. 1 to 7, this is merely one embodiment of the driving circuits proposed in the present invention, and the technical idea of the invention is not necessarily limited thereto.

FIG. 1 is a detailed circuit diagram of the micro LED driving circuit according to an embodiment of the present invention.

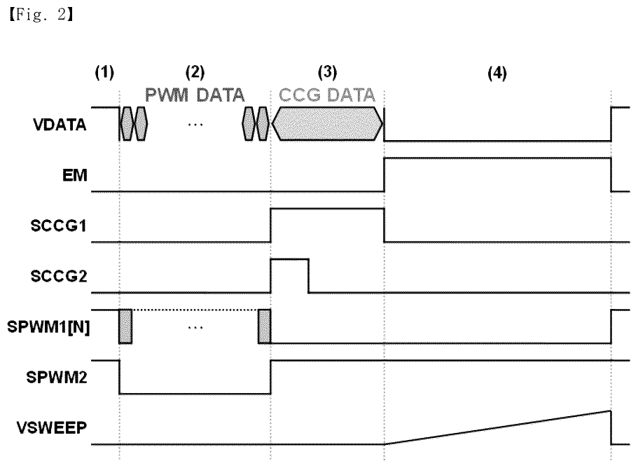

FIG. 2 is a signal flowchart of the micro LED driving circuit according to an embodiment of the present invention.

The micro LED driving circuit proposed in an embodiment of the present invention includes a PWM circuit and a CCG circuit. The micro LED driving circuit may consist of a total of 14T2C, including one capacitor and one driving transistor per circuit block, as well as a plurality of switching transistors

In the driving circuit shown in FIGS. 1 and 2, the PWM circuit and the CCG circuit may each include one PWM circuit driving transistor (T_{PWM}) and one CCG circuit driving transistor (T_{CCG}). Furthermore, the PWM circuit and the CCG circuit may each include one PWM circuit capacitor (C2=C_{PWM}) and one CCG circuit capacitor (C1=C_{CCG}), respectively.

The PWM circuit may additionally include a plurality of PWM circuit switching transistors in addition to the single PWM circuit driving transistor. Preferably, it may be configured to include seven additional switching transistors.

The CCG circuit may also include a plurality of CCG circuit switching transistors in addition to the single CCG circuit driving transistor. Preferably, it may be configured to include five additional switching transistors.

The PWM circuit can simultaneously perform the injection of PWM data (PWM data input) and the compensation of the threshold voltage (T_{PWM} V_{TH}) of the PWM circuit driving transistor using only one capacitor (C2=C_{PWM}).

The CCG circuit can also simultaneously perform the injection of CCG data (CCG data input) and the compensation of the threshold voltage (T_{PWM} V_{TH}) of the CCG circuit driving transistor using only one capacitor (C1=C_{CCG}).

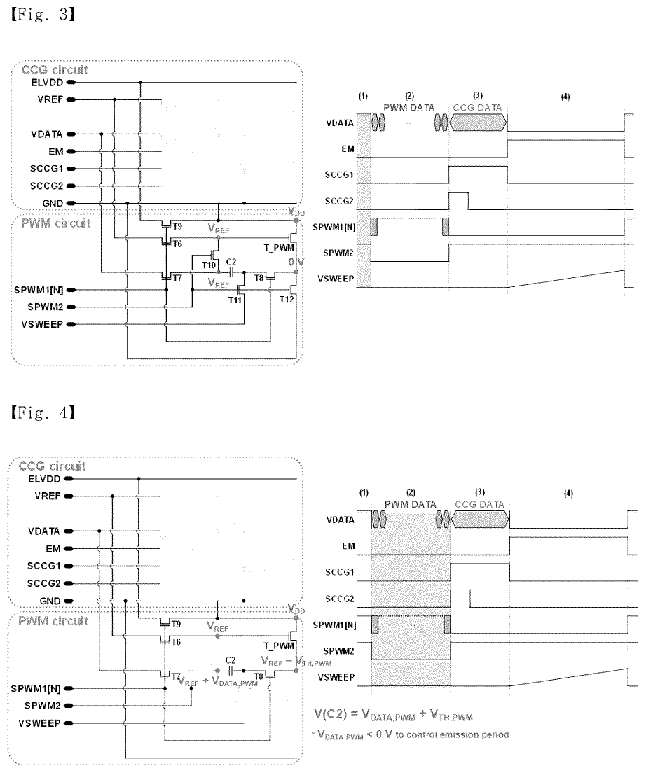

Hereinafter, FIGS. 3 to 7 detail the operational principles of the micro LED driving circuit proposed in the embodiment through the signal diagrams of the micro LED driving circuit.

FIG. 3 is a diagram illustrating the operational principle in the first stage (Reset stage) of the micro LED driving circuit according to an embodiment of the present invention.

In the first stage, all node voltages may be reset.

FIG. 4 is a diagram illustrating the operational principle in the second stage (PWM Data Input & T_{PWM} Circuit V_{TH} Compensation) of the micro LED driving circuit according to an embodiment of the present invention.

In the second stage above, the PWM data can first be the voltage of the PWM circuit capacitor (V(C2)), V_{DATA,PWM}+V_{TH,PWM}. Additionally, in this stage, V_{DATA,PWM} may be controlled to be below 0V to regulate the emission time of the micro LED.

In the second stage, both the injection of PWM data and the threshold voltage compensation of the PWM circuit driving transistor may be simultaneously performed through a single PWM circuit capacitor (C2=C_{PWM}).

FIG. 5 is a diagram illustrating the operational principle at the initial phase of the third stage (CCG Data Input & T_{PWM} Circuit V_{TH} Compensation) of the micro LED driving circuit according to an embodiment of the present invention.

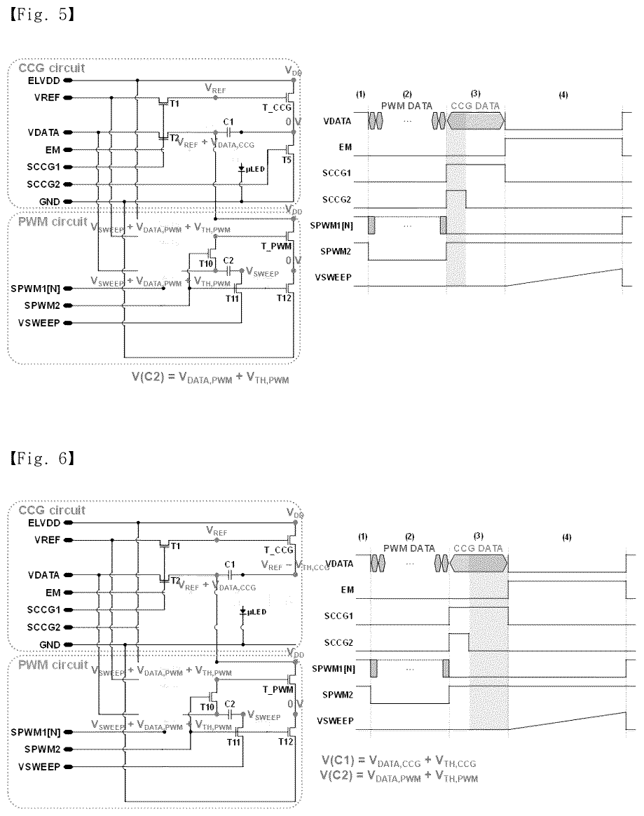

FIG. 6 is a diagram illustrating the operational principle at the later phase of the third stage (CCG Data Input & T_{PWM} Circuit V_{TH} Compensation) of the micro LED driving circuit according to an embodiment of the present invention.

In the later phase of the third stage shown in FIG. 6, the voltage V(C1) of the CCG circuit capacitor C1=C_{CCG}) may become V_{DATA,CCG}+V_{TH,CCG}. Similar to the PWM circuit unit, in the third stage, the CCG circuit unit may also perform both CCG data injection and threshold voltage compensation of the CCG circuit driving transistor simultaneously through a single CCG circuit capacitor (C1=C_{CCG}).

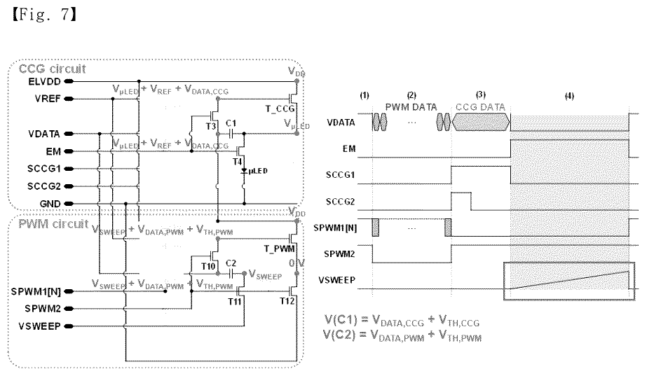

FIG. 7 is a diagram illustrating the operational principle of the fourth stage (Emission) of the micro LED driving circuit according to an embodiment of the present invention.

In the fourth stage, the V_{SWEEP} value gradually increases during the emission time of the micro LED. Additionally, when the Vos value of the PWM circuit driving transistor (T_{PWM}), defined as V_{SWEEP}+V_{DATA,PWM}+V_{TH,PWM}, exceeds the V_{TH,PWM} value, the PWM circuit driving transistor (T_{PWM}) may turn on (turn-on state).

Afterwards, when one side of the CCG circuit capacitor (C1=C_{CCG}) is connected to the ground (GND), the voltage (V(C1)) of the CCG circuit capacitor can be discharged, thereby ending the light-emitting time of the micro LED and enabling the adjustment of the emission duration.

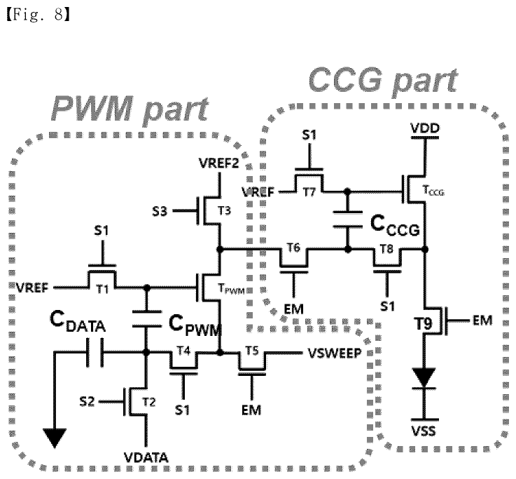

Hereinafter, with reference to FIGS. 8 to 12, a detailed explanation will be provided of the micro LED driving circuit and its operation method proposed in another embodiment of the present invention. FIGS. 8 to 12 present a circuit diagram that differs from that shown in FIGS. 1 to 7; however, this is merely another embodiment of the driving circuit proposed in the present invention, and the technical spirit of the invention is not necessarily limited thereto.

FIG. 8 is a detailed circuit diagram of a micro LED driving circuit according to another embodiment of the present invention.

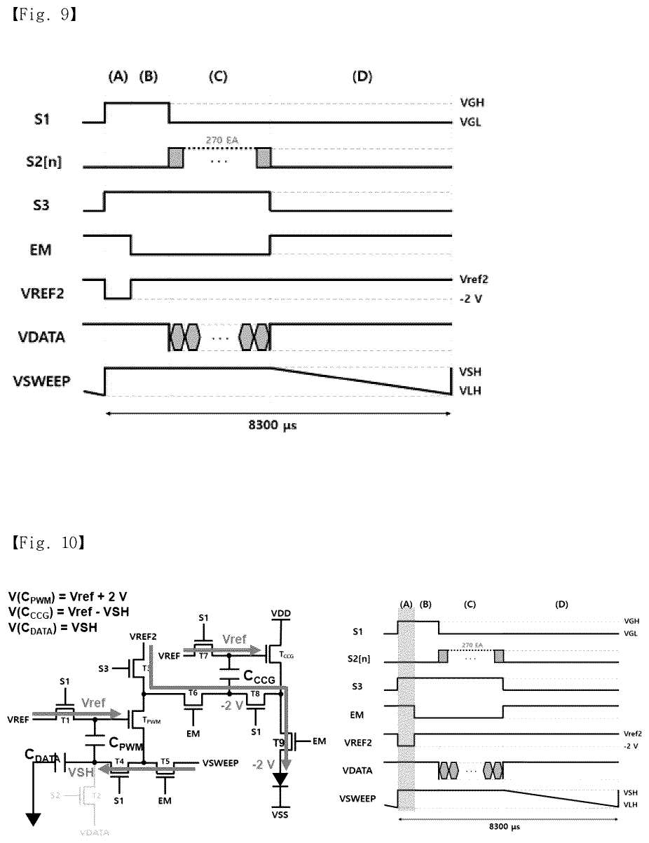

FIG. 9 is a signal sequence diagram of a micro LED driving circuit according to another embodiment of the present invention.

The micro LED driving circuit proposed in another embodiment of the present invention also includes a PWM circuit unit and a CCG circuit unit. This micro LED driving circuit can be configured as an 11T3C circuit, comprising one capacitor and one driving transistor for each circuit unit, multiple additional switching transistors, and one data voltage storage capacitor included in the PWM circuit unit.

In the driving circuit shown in FIGS. 8 and 9, the PWM circuit unit and the CCG circuit unit each include one PWM circuit driving transistor (T_{PWM}) and one CCG circuit driving transistor (T_{CCG}), respectively. Additionally, the PWM circuit unit and the CCG circuit unit each include one PWM circuit capacitor (C_{PWM}) and one CCG circuit capacitor (C_{CCG}), respectively.

The PWM circuit capacitor is capable of sensing the threshold voltage of the PWM circuit driving transistor (T_{PWM}), and the CCG circuit capacitor is capable of sensing the threshold voltage of the CCG circuit driving transistor (T_{CCG}). The PWM circuit unit may additionally include a data voltage storage capacitor (C_{DATA}) for storing V_{DATA}.

The PWM circuit unit may include, in addition to one PWM circuit driving transistor, multiple additional PWM circuit switching transistors. Preferably, the PWM circuit unit may be configured to include five additional switching transistors.

The CCG circuit unit may include, in addition to one CCG circuit driving transistor, multiple additional CCG circuit switching transistors. Preferably, the CCG circuit unit may be configured to include four additional switching transistors.

Hereinafter, FIGS. 10 to 13 will be referenced to provide a detailed explanation of the operational principles of the micro LED driving circuit proposed in the embodiment, using its signal diagrams.

FIG. 10 is a diagram illustrating the operational principle of the first stage (Reset stage) of the micro LED driving circuit according to an embodiment of the present invention.

FIG. 10 is a diagram illustrating the operational principle of the first stage (Reset stage) of the micro LED driving circuit according to an embodiment of the present invention.

In the first stage, the voltage across the capacitance and the anode voltage of the micro LED are initialized. According to the embodiment shown in FIG. 10, in the first stage, V(C_{PWM})=V_{ref}+2V, V(C_{CCG})=V_{ref}−V_{SH}, and V(C_{DATA})=V_{SH}.

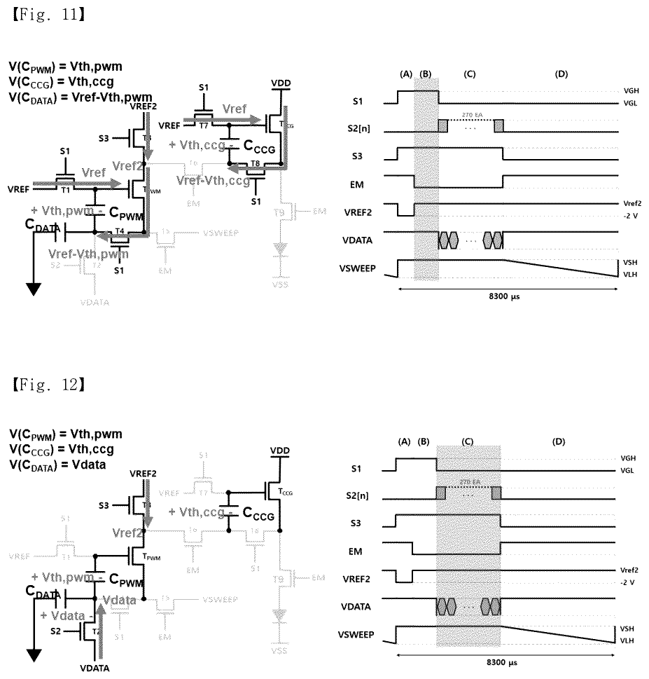

FIG. 11 is a diagram explaining the operating principle of the second stage (V_{TH} Compensation of T_{PWM} & T_{CCG}) of the micro LED driving circuit according to one embodiment of the present invention.

In the second stage, a threshold voltage sensing process (Vₜₕ sensing period) occurs, and in this stage, the threshold voltage of the driving transistors of the CCG circuit and the PWM circuit can be compensated in a source follower manner.

In the second stage, the capacitor (C_{CCG}) of the CCG circuit may store the threshold voltage of the CCG circuit driving transistor (T_{CCG}), and the capacitor (C_{PWM}) of the PWM circuit may individually store the threshold voltage of the PWM circuit driving transistor (T_{PWM}).

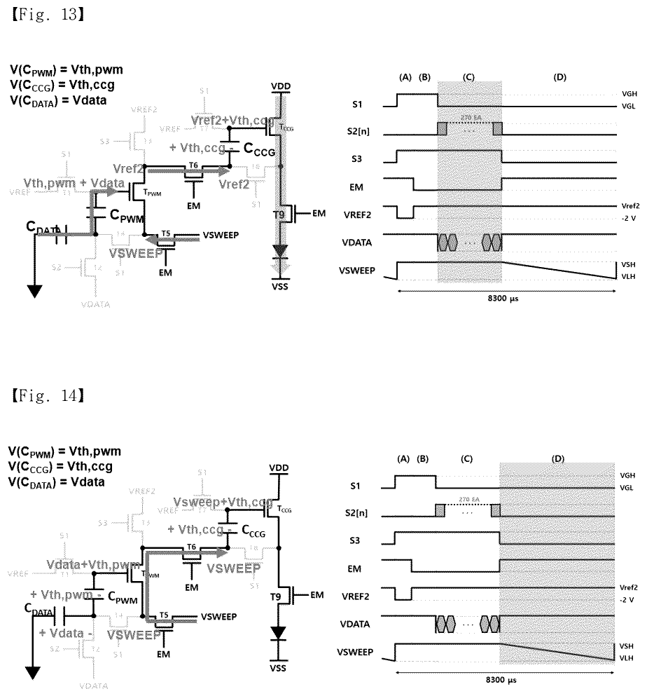

FIG. 12 is a drawing explaining the operating principle in the third stage (PWM Data Input) of the micro LED driving circuit according to one embodiment of the present invention.

In the third stage, the data voltage can be stored in the PWM circuit data capacitor (C_{DATA}) through the switching transistor (T2) of the PWM circuit directly connected to the data voltage (V_{DATA}).

FIG. 13 is a drawing explaining the operating principle at the beginning of the fourth stage (Emission) of a micro LED driving circuit according to one embodiment of the present invention.

At the beginning of the above 4th stage, V_{SWEEP} still shows a large value.

At this time, if V_{GS, PWM}−V_{TH, PWM}=V_{TH, PWM}+V_{DATA}−V_{SWEEP}−V_{TH, PWM}=V_{DATA}−V_{SWEEP}<0, the driving transistor of the PWM circuit turns off.

Additionally, the drain of T_{PWM} floats to V_{REF2}, and when the gate voltage of T_{CCG} becomes equal to V_{REF2}+V_{TH, CCG}(high) by C_{CCG}, the micro LED lights up.

FIG. 14 is a drawing explaining the operating principle of the micro LED driving circuit in the latter stage (Emission) according to one embodiment of the present invention.

In the fourth stage above, V_{SWEEP} slowly decreases.

At this time, when the state of V_{GS, PWM}−V_{TH, PWM}=V_{DATA}−V_{SWEEP}>0 is reached, the driving transistor (T_{PWM}) of the PWM circuit part is turned on. Afterwards, when the voltages at both ends of the driving transistor (T_{PWM}) of the PWM circuit part both become V_{SWEEP} (low), the voltage of the driving transistor (T_{CCG}) of the CCG circuit part becomes V_{SWEEP}+V_{TH, CCG}, and the micro LED stops emitting light.

The characteristic parts of the driving circuit of the micro LED proposed above are summarized as follows.

A micro LED driving circuit according to one embodiment of the present invention includes a PWM circuit unit for controlling the light-emitting time of the micro LED; and a CCG circuit unit for controlling a constant current to be supplied during light-emitting of the micro LED based on the PWM data voltage (V_{DATA_PWM}).

According to one embodiment, the PWM circuit unit may include a PWM circuit unit driving transistor (T_{PWM}) and a PWM circuit unit capacitor (C_{PWM}), and the CCG circuit unit may include a CCG circuit unit driving transistor and a CCG circuit unit capacitor.

According to one embodiment, the PWM circuit capacitor (C_{PWM}) may simultaneously perform injection of PWM data (PWM data input) and compensation for a threshold voltage (T_{PWM} V_{TH}) of a PWM circuit driving transistor, and the CCG circuit capacitor (C_{CCG}) may simultaneously perform injection of CCG data (CCG data input) and compensation for a threshold voltage (T_{CCG} V_{TH}) of a CCG circuit driving transistor.

According to one embodiment, after the injection of the PWM data (PWM data input) and compensation of the threshold voltage (T_{PWM} V_{TH}) of the PWM circuit driving transistor occur, the injection of the CCG data (CCG data input) and compensation of the threshold voltage (T_{CCG} V_{TH}) of the CCG circuit driving transistor may occur.

In one embodiment, the PWM circuit may further include seven switching transistors, and the CCG circuit may further include five switching transistors.

According to one embodiment, the V_{SWEEP} value may gradually increase during the light-emitting time of the micro LED, and when one side of the CCG circuit capacitor (C_{CCG}) is connected to ground, the CCG circuit capacitor may be discharged and the micro LED may be turned off, thereby controlling the light-emitting time.

According to one embodiment, the PWM circuit capacitor (C_{PWM}) may sense a threshold voltage of the PWM circuit driving transistor (T_{PWM}), and the CCG circuit capacitor (C_{CCG}) may sense a threshold voltage of the CCG circuit driving transistor (T_{CCG}).

According to one embodiment, the threshold voltage sensing of the PWM circuit driving transistor (T_{PWM}) and the threshold voltage sensing of the CCG circuit driving transistor (T_{CCG}) may be performed in the same circuit stage.

According to one embodiment, the threshold voltage sensing of the PWM circuit unit and the CCG circuit unit may be performed in a source follower manner.

According to one embodiment, the PWM circuit capacitor (C_{PWM}) may store the threshold voltage of the PWM circuit driving transistor (T_{PWM}), and the CCG circuit capacitor (C_{CCG}) may store the threshold voltage of the CCG circuit driving transistor (T_{CCG}).

According to one embodiment, the PWM circuit may further include a data voltage storage capacitor (C_{DATA}).

According to one embodiment, the data voltage storage capacitor (C_{DATA}) may store the data voltage (V_{DATA}) through the switching transistor of the PWM circuit, which is directly connected to the data voltage.

According to one embodiment, the PWM circuit may further include a total of five PWM circuit switching transistors, and the CCG circuit may further include a total of four switching transistors.

In one embodiment, the micro LED may emit light while V_{SWEEP} gradually decreases and then stops emitting light.

According to one embodiment, the driving circuit may operate in four stages: stage 1 to stage 4.

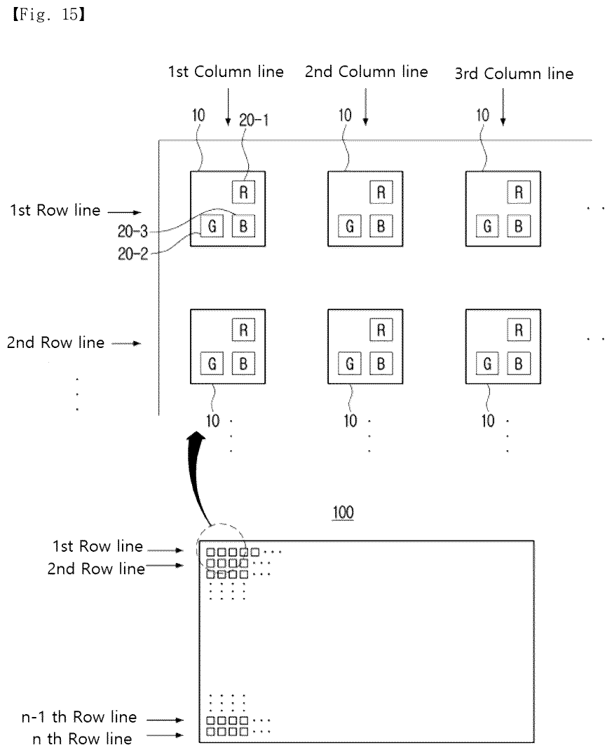

FIG. 15 is a schematic diagram showing an embodiment of a pixel structure of a micro LED display device equipped with a micro LED driving circuit according to an embodiment of the present invention.

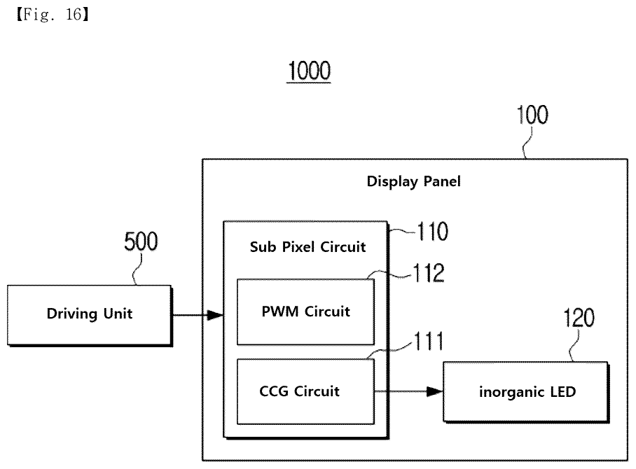

FIG. 16 is a block diagram showing the configuration of a micro LED display device equipped with a micro LED driving circuit according to one embodiment of the present invention.

According to another embodiment of the present invention, a micro LED display device may include a display panel including a pixel array in which pixels composed of a plurality of inorganic light-emitting elements are arranged in a plurality of row lines, and a sub-pixel circuit provided for each of the plurality of inorganic light-emitting elements and providing a driving current to the inorganic light-emitting elements; and a driving unit which sets an image data voltage to the sub pixel circuits of the display panel in a row-line order during a data setting section, and drives the sub-pixel circuits so that the driving current is provided to the inorganic light-emitting elements of the pixel array in a row-line order based on a sweep signal that sweeps from a first voltage to a second voltage and the set image data voltage during a light-emitting section; wherein the sub pixel circuit may include a PWM circuit unit which adjusts a light-emitting time of the micro LED; and a CCG circuit unit which controls so that a constant current flows during light-emitting of the micro LED.

In one embodiment, the sub-pixel circuit may include a micro LED driving circuit according to one embodiment of the present invention.

The above description is merely an illustrative description of the technical idea of the present invention, and those skilled in the art will appreciate that various modifications and variations may be made without departing from the essential characteristics of the present invention. Accordingly, the embodiments disclosed in the present invention are not intended to limit the technical idea of the present invention but to explain it, and the scope of the technical idea of the present invention is not limited by these embodiments. The protection scope of the present invention should be interpreted by the following claims, and all technical ideas within a scope equivalent thereto should be interpreted as being included in the scope of the rights of the present invention.

1. A micro LED driving circuit, comprising:
a PWM circuit configured to control the emission time of the micro LED; and
a CCG circuit configured to control the supply of a constant current during the emission of the micro LED based on the PWM data voltage.

2. The micro LED driving circuit according to claim 1,
wherein the PWM circuit comprises a PWM circuit driving transistor (T_{PWM}) and a PWM circuit capacitor (C_{PWM}), and
the CCG circuit comprises a CCG circuit driving transistor and a CCG circuit capacitor.

3. The micro LED driving circuit according to claim 2,
wherein the PWM circuit capacitor (C_{PWM}) is configured to simultaneously perform the injection of PWM data (PWM data input) and the compensation of the threshold voltage (T_{PWM} V_{TH}) of the PWM circuit driving transistor, and
the CCG circuit capacitor (C_{CCG}) is configured to simultaneously perform the injection of CCG data (CCG data input) and the compensation of the threshold voltage (T_{CCG} V_{TH}) of the CCG circuit driving transistor.

4. The micro LED driving circuit according to claim 3,
wherein, after the injection of PWM data (PWM data input) and the compensation of the threshold voltage (T_{PWM} V_{TH}) of the PWM circuit driving transistor occur, the injection of CCG data (CCG data input) and the compensation of the threshold voltage (T_{CCG} V_{TH}) of the CCG circuit driving transistor occur.

5. The micro LED driving circuit according to claim 3,
wherein the PWM circuit further comprises seven switching transistors, and
the CCG circuit further comprises five switching transistors.

6. The micro LED driving circuit according to claim 1,
wherein the V_{SWEEP} value gradually increases during the emission time of the micro LED, and the CCG circuit capacitor (C_{CCG}) discharges as one side of the CCG circuit capacitor is connected to the ground, thereby extinguishing the micro LED and controlling the emission time.

7. The micro LED driving circuit according to claim 2,
wherein the PWM circuit capacitor (C_{PWM}) senses the threshold voltage of the PWM circuit driving transistor (T_{PWM}), and
the CCG circuit capacitor (C_{CCG}) senses the threshold voltage of the CCG circuit driving transistor (T_{CCG}).

8. The micro LED driving circuit according to claim 7,
wherein the threshold voltage sensing of the PWM circuit driving transistor (T_{PWM}) and the threshold voltage sensing of the CCG circuit driving transistor (T_{CCG}) are performed in the same circuit stage.

9. The micro LED driving circuit according to claim 7,
wherein the threshold voltage sensing of the PWM circuit and the CCG circuit is performed using a source follower method.

10. The micro LED driving circuit according to claim 2,
wherein the PWM circuit capacitor (C_{PWM}) stores the threshold voltage of the PWM circuit driving transistor (T_{PWM}), and
the CCG circuit capacitor (C_{CCG}) stores the threshold voltage of the CCG circuit driving transistor (T_{CCG}).

11. The micro LED driving circuit according to claim 2,
wherein the PWM circuit further comprises a data voltage storage capacitor (C_{DATA}).

12. The micro LED driving circuit according to claim 11,
wherein the data voltage storage capacitor (C_{DATA}) stores the data voltage (V_{DATA}) through the switching transistor of the PWM circuit, which is directly connected to the data voltage.

13. The micro LED driving circuit according to claim 7,
wherein the PWM circuit further comprises a total of five PWM circuit switching transistors, and
the CCG circuit further comprises a total of four switching transistors.

14. The micro LED driving circuit according to claim 7,
wherein the micro LED emits light while the V_{SWEEP} gradually decreases, and the emission is interrupted.

15. The micro LED driving circuit according to claim 1,
wherein the driving circuit operates by being divided into a total of four stages from a first stage to a fourth stage.

16. A display device including a micro LED, comprising:
a display panel including:
a pixel array in which pixels composed of a plurality of inorganic light-emitting elements are arranged in a plurality of row lines, and
a sub-pixel circuit provided for each of the plurality of inorganic light-emitting elements and configured to supply a driving current to the inorganic light-emitting elements; and
a driving unit configured to:
set image data voltages in the sub-pixel circuits of the display panel in row line order during a data setting period, and
drive the sub-pixel circuits such that the driving current is supplied to the inorganic light-emitting elements of the pixel array in row line order based on a sweep signal that sweeps from a first voltage to a second voltage during a light-emission period and the set image data voltage,
wherein the sub-pixel circuit comprises:
a PWM circuit configured to control the emission time of the micro LED; and
a CCG circuit configured to control a constant current to flow during the emission of the micro LED.

17. The micro LED display device according to claim 16,
wherein the sub-pixel circuit includes the-a micro LED driving circuit comprising:
a PWM circuit configured to control the emission time of the micro LED; and
a CCG circuit configured to control the supply of a constant current during the emission of the micro LED based on the PWM data voltage.
